(19) United States
(12) Patent Application Publication
(10) Pub. No.: US 2010/0265232 A1
(43) Pub. Date: Oct. 21, 2010

(54) PLASMA DISPLAY APPARATUS

(76) Inventors: Yunkwon Jung, Gumi-city (KR); Sangyoon Soh, Gumi-city (KR); Mukhee Kim, Gumi-city (KR)

Correspondence Address: KED & ASSOCIATES, LLP, P.O. Box 221200, Chantilly, VA, 20153-1200, US

(21) Appl. No.: 12/581,330

(22) Filed: Oct. 19, 2009

(30) Foreign Application Priority Data
Apr. 21, 2009 (KR) 10-2009-0034485

(51) Int. Cl. G09G 5/00; G09G 3/28

(52) U.S. Cl. 345/211; 345/60

(57) ABSTRACT

A plasma display apparatus is disclosed. The plasma display apparatus includes a plasma display panel including an electrode and a driver that supplies a sustain signal to the electrode in a sustain period of a subfield. The driver supplies a first type sustain signal to the electrode when a data load of an input image is a first load and supplies a second type sustain signal to the electrode when the data load of the input image is a second load greater than the first load.

This application claims the benefit of Korea Patent Application No.10-2009-0034485 filed on Apr. 21, 2009, the entire contents of which is incorporated herein by reference for all purposes as if fully set forth herein.

### BACKGROUND OF THE INVENTION

1. Field of the Invention

Embodiments of the invention relate to a plasma display apparatus.

2. Discussion of the Related Art

A plasma display apparatus includes a plasma display panel. The plasma display panel includes a phosphor layer inside discharge cells partitioned by barrier ribs and a plurality of electrodes.

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

### SUMMARY OF THE INVENTION

In one aspect, there is a plasma display apparatus comprising a plasma display panel including an electrode and a driver that supplies a sustain signal to the electrode in a sustain period of a subfield, wherein the driver supplies a first type sustain signal to the electrode when a data load of an input image is a first load and supplies a second type sustain signal to the electrode when the data load of the input image is a second load greater than the first load, wherein the second type sustain signal includes a 1st period during which a voltage of the second type sustain signal rises from a ground level voltage to a 1st voltage, a 2nd period during which the voltage falls from the 1st voltage to a 2nd voltage greater than the ground level voltage, a 3rd period during which the voltage rises from the 2nd voltage to a 3rd voltage greater than the 1st voltage, a 4th period during which the voltage falls from the 3rd voltage to a 4th voltage greater than the 1st voltage, and a 5th period during which the voltage rises from the 4th voltage to a 5th voltage greater than the 3rd voltage, wherein the first type sustain signal includes a 10th period during which a voltage of the first type sustain signal rises from the ground level voltage to a 10th voltage, a 11th period during which the voltage rises from the 10th voltage to an 11th voltage, and a 12th period during which the voltage rises from the 11th voltage to a 12th voltage. 1

In another aspect, there is a plasma display apparatus comprising a plasma display panel including an electrode and a driver that supplies a sustain signal to the electrode in a sustain period of a subfield, wherein the driver supplies a first type sustain signal to the electrode when a data load of an input image is a first load and supplies a second type sustain signal to the electrode when the data load of the input image is a second load greater than the first load, wherein one first type sustain signal generates one discharge, and one second type sustain signal generates three discharges.

In another aspect, there is a plasma display apparatus comprising a plasma display panel including an electrode and a driver that supplies a sustain signal to the electrode in a sustain period of a subfield, the driver including a capacitor, a first inductor positioned between the capacitor and the electrode, first and second switches that are positioned between the first inductor and the capacitor to be parallel to each other, a third switch positioned between the electrode and a sustain voltage source generating a sustain voltage, a fourth switch positioned between the electrode and a ground, and a fifth switch and a second inductor that are positioned between a node between the electrode and the first inductor and the sustain voltage source.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary configuration of a plasma display apparatus according to an embodiment;

FIG. 2 illustrates an exemplary structure of a plasma display panel;

FIG. 3 illustrates a frame for achieving a gray scale of an image;

FIG. 4 illustrates an exemplary method of driving a plasma display panel;

FIGS. 5 to 8 illustrate in detail a sustain signal;

FIGS. 9 to 15 illustrate a configuration and an operation of a driver; and

FIGS. 16 and 17 illustrate a comparative example.

### DETAILED DESCRIPTION OF THE EMBODIMENTS

Reference will now be made in detail embodiments of the invention examples of which are illustrated in the accompanying drawings.

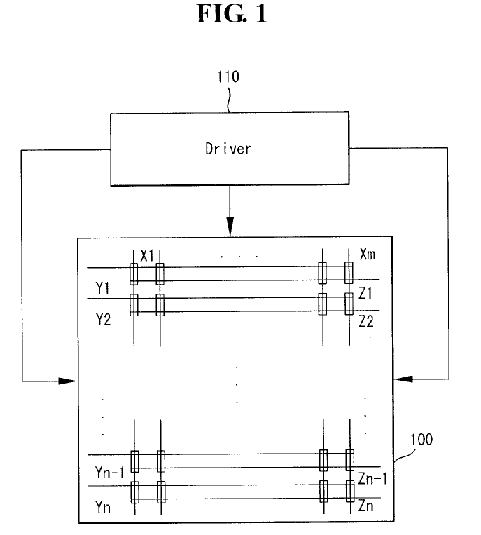

FIG. 1 illustrates an exemplary configuration of a plasma display apparatus according to an embodiment.

As shown in FIG. 1, the plasma display apparatus according to the exemplary embodiment may include a plasma display panel 100 and a driver 110.

The plasma display panel 100 may include scan electrodes Y1 to Yn and sustain electrodes Z1 to Zn positioned parallel to each other, and address electrodes X1 to Xm positioned to cross the scan electrodes Y1 to Yn and the sustain electrodes Z1 to Zn. The plasma display panel 100 may display an image in a frame including a plurality of subfields.

The driver 110 may supply driving signals to at least one of the scan electrodes Y1 to Yn, the sustain electrodes Z1 to Zn, or the address electrodes X1 to Xm and allow the image to be displayed on the screen of the plasma display panel 100.

Although FIG. 1 shows the driver 110 formed in the form of a signal board, the driver 110 may be formed in the form of a plurality of boards depending on the electrodes of the plasma display panel 100. For example, the driver 110 may include a first driver (not shown) for driving the scan electrodes Y1 to Yn, a second driver for driving the sustain electrodes Z1 to Zn, and a third driver (not shown) for driving the address electrodes X1 to Xm.

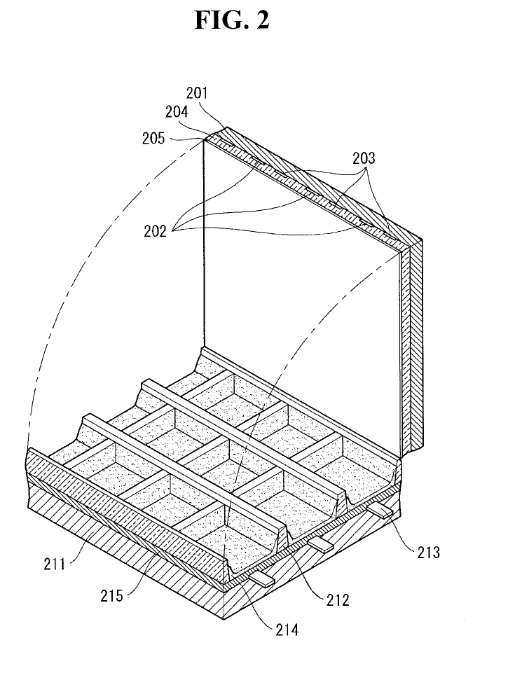

FIG. 2 illustrates an exemplary structure of the plasma display panel.

As shown in FIG. 2, the plasma display panel may include a front substrate 201, on which a scan electrode 202 and a sustain electrode 203 are formed substantially parallel to each other, and a rear substrate 211 on which an address electrode 213 is formed to cross the scan electrode 202 and the sustain electrode 203.

An upper dielectric layer 204 may be formed on the scan electrode 202 and the sustain electrode 203 to limit a discharge current of the scan electrode 202 and the sustain electrode 203 and to provide insulation between the scan electrode 202 and the sustain electrode 203. A protective layer 205 may be formed on the upper dielectric layer 204 to facilitate discharge conditions. The protective layer 205 may be formed of a material having a high secondary electron emission coefficient, for example, magnesium oxide (MgO).

A lower dielectric layer 215 may be formed on the address electrode 213 to provide insulation between the address electrodes 213.

Barrier ribs 212 of a stripe type, a well type, a delta type, a honeycomb type, etc. may be formed on the lower dielectric layer 215 to partition discharge spaces (i.e., discharge cells). Hence, a first discharge cell emitting red light, a second discharge cell emitting blue light, and a third discharge cell emitting green light, etc. may be formed between the front substrate 201 and the rear substrate 211.

The address electrode 213 may cross the scan electrode 202 and the sustain electrode 203 in one discharge cell. Namely, each discharge cell is formed at a crossing of the scan electrode 202, the sustain electrode 203, and the address electrode 213.

Each of the discharge cells partitioned by the barrier ribs 212 may be filled with a predetermined discharge gas.

A phosphor layer 214 may be formed inside the discharge cells to emit visible light for an image display during an address discharge. For example, first, second, and third phosphor layers that respectively generate red, blue, and green light may be formed inside the discharge cells.

While the address electrode 213 may have a substantially constant width or thickness, a width or thickness of the address electrode 213 inside the discharge cell may be different from a width or thickness of the address electrode 213 outside the discharge cell. For example, a width or thickness of the address electrode 213 inside the discharge cell may be larger than a width or thickness of the address electrode 213 outside the discharge cell.

When a predetermined signal is supplied to at least one of the scan electrode 202, the sustain electrode 203, and the address electrode 213, a discharge may occur inside the discharge cell. The discharge may allow the discharge gas filled in the discharge cell to generate ultraviolet rays. The ultraviolet rays may be incident on phosphor particles of the phosphor layer 214, and then the phosphor particles may emit visible light. Hence, an image may be displayed on the screen of the plasma display panel 100.

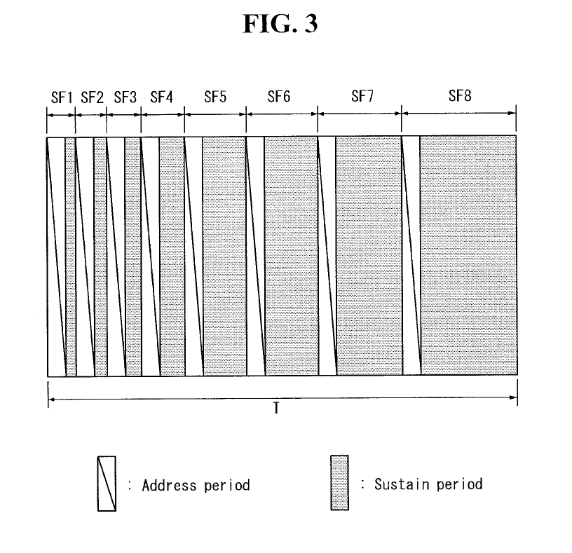

FIG. 3 illustrates a frame for achieving a gray scale of an image.

As shown in FIG. 3, a frame for achieving a gray scale of an image may include a plurality of subfields. Each of the plurality of subfields may be divided into an address period and a sustain period. During the address period, the discharge cells not to generate a discharge may be selected or the discharge cells to generate a discharge may be selected. During the sustain period, a gray scale may be achieved depending on the number of discharges.

For example, if an image with 256-gray level is to be displayed, as shown in FIG. 3, a frame may be divided into 8 subfields SF1 to SF8. Each of the 8 subfields SF1 to SF8 may include an address period and a sustain period.

Furthermore, at least one of a plurality of subfields of a frame may further include a reset period for initialization. At least one of a plurality of subfields of a frame may not include a sustain period.

The number of sustain signals supplied during the sustain period may determine a gray level of each of the subfields. For example, in such a method of setting a gray level of a first subfield at 20 and a gray level of a second subfield at 21, the sustain period increases in a ratio of 2ⁿ (where, n=0, 1, 2, 3, 4, 5, 6, 7) in each of the subfields. Hence, various gray levels of an image may be achieved by controlling the number of sustain signals supplied during the sustain period of each subfield depending on a gray level of each subfield.

Although FIG. 3 shows that one frame includes 8 subfields, the number of subfields constituting a frame may vary. For example, a frame may include 10 or 12 subfields. Further, although FIG. 3 shows that the subfields of the frame are arranged in increasing order of gray level weight, the subfields may be arranged in decreasing order of gray level weight or may be arranged regardless of gray level weight.

At least one of a plurality of subfields of a frame may be a selective erase subfield, or at least one of the plurality of subfields of the frame may be a selective write subfield.

If a frame includes at least one selective erase subfield and at least one selective write subfield, it may be preferable that a first subfield or first and second subfields of a plurality of subfields of the frame is/are a selective write subfield and the other subfields are selective erase subfields.

In the selective erase subfield, a discharge cell to which a data signal is supplied during an address period is turned off during a sustain period following the address period. In other words, the selective erase subfield may include an address period, during which a discharge cell to be turned off is selected, and a sustain period during which a sustain discharge occurs in the discharge cell that is not selected during the address period.

In the selective write subfield, a discharge cell to which a data signal is supplied during an address period is turned on during a sustain period following the address period. In other words, the selective write subfield may include a reset period during which discharge cells are initialized, an address period during which a discharge cell to be turned on is selected, and a sustain period during which a sustain discharge occurs in the discharge cell selected during the address period.

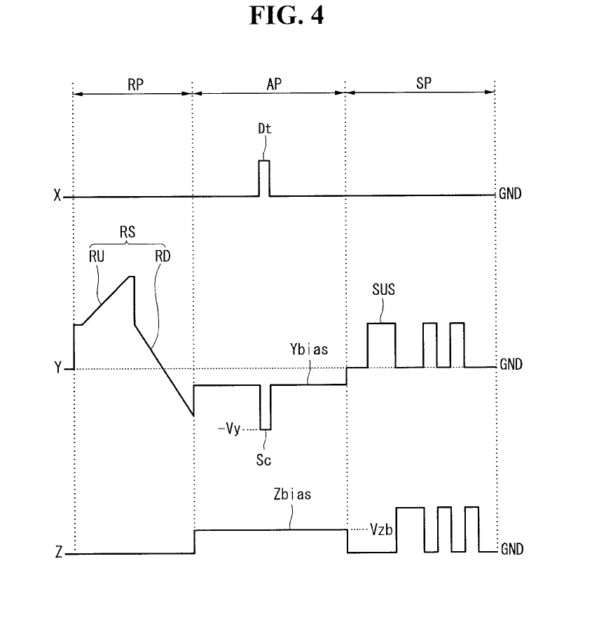

FIG. 4 illustrates an exemplary method of driving the plasma display panel. A driving waveform to be described later is supplied by the driver 110 of FIG. 1.

As shown in FIG. 4, a reset signal RS may be supplied to the scan electrode Y during a reset period RP for initialization of at least one of a plurality of subfields of a frame. The reset signal RS may include a ramp-up signal RU with a gradually rising voltage and a ramp-down signal RD with a gradually falling voltage.

More specifically, the ramp-up signal RU may be supplied to the scan electrode Y during a setup period of the reset period RP, and the ramp-down signal RD may be supplied to the scan electrode Y during a set-down period following the setup period. The ramp-up signal RU may generate a weak dark discharge (i.e., a setup discharge) inside the discharge cells. Hence, the wall charges may be uniformly distributed inside the discharge cells. The ramp-down signal RD subsequent to the ramp-up signal RU may generate a weak erase discharge (i.e., a set-down discharge) inside the discharge cells. Hence, the remaining wall charges may be uniformly distributed inside the discharge cells to the extent that an address discharge occurs stably.

During an address period AP following the reset period RP, a scan reference signal Ybias having a voltage greater than a minimum voltage of the ramp-down signal RD may be supplied to the scan electrode Y. In addition, a scan signal Sc falling from a voltage of the scan reference signal Ybias may be supplied to the scan electrode Y.

A pulse width of a scan signal supplied to the scan electrode during an address period of at least one subfield of a frame may be different from pulse widths of scan signals supplied during address periods of the other subfields of the frame. A pulse width of a scan signal in a subfield may be greater than a pulse width of a scan signal in a next subfield. For example, a pulse width of the scan signal may be gradually reduced in the order of 2.6 μs, 2.3 μs, 2.1 μs, 1.9 μs, etc. or may be reduced in the order of 2.6 μs, 2.3 μs, 2.3 μs, 2.1 μs, . . . , 1.9 μs, 1.9 μs, etc. in the successively arranged subfields.

As above, when the scan signal Sc is supplied to the scan electrode Y, a data signal Dt corresponding to the scan signal Sc may be supplied to the address electrode X. As a voltage difference between the scan signal Sc and the data signal Dt is added to a wall voltage obtained by the wall charges produced during the reset period RP, an address discharge may occur inside the discharge cell to which the data signal Dt is supplied. In addition, during the address period AP, a sustain reference signal Zbias may be supplied to the sustain electrode Z, so that the address discharge efficiently occurs between the scan electrode Y and the address electrode X.

During a sustain period SP following the address period AP, a sustain signal SUS may be supplied to at least one of the scan electrode Y or the sustain electrode Z. In FIG. 4, the sustain signal SUS is alternately supplied to the scan electrode Y and the sustain electrode Z. As the wall voltage inside the discharge cell selected by performing the address discharge is added to the sustain voltage Vs of the sustain signal SUS, every time the sustain signal SUS is supplied, a sustain discharge, i.e., a display discharge may occur between the scan electrode Y and the sustain electrode Z.

An image may be displayed on the plasma display panel through the above-described driving method.

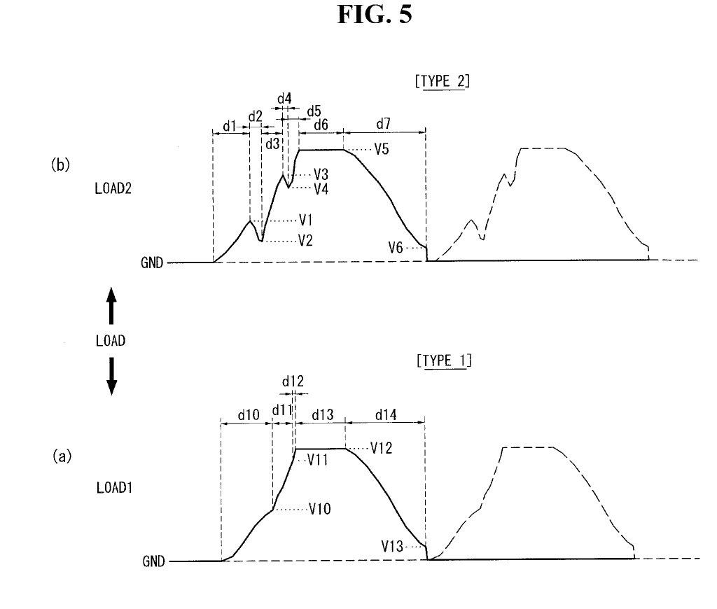

FIGS. 5 to 8 illustrate in detail a sustain signal.

As shown in FIG. 5, sustain signals of different types may be used depending on a data load of an input image. More specifically, when the data load of the input image is a first load LOAD1 as shown in (a) of FIG. 5, a first type sustain signal TYPE1 may be used. When the data load of the input image is a second load LOAD2 greater than the first load LOAD1 as shown in (b) of FIG. 5, a second type sustain signal TYPE2 may be used.

The second type sustain signal TYPE2 may include a period during which a voltage of the second type sustain signal TYPE2 sequentially rises, falls, and again rises. On the other hand, while a voltage of the first type sustain signal TYPE1 rises, the voltage of the first type sustain signal TYPE1 does not fall.

Although it is not shown, an energy recovery circuit may supply a voltage stored in the energy recovery circuit to the scan electrode or the sustain electrode during 10th, 11th, and 12th periods d10, d11, and d12 of the first type sustain signal TYPE1. Further, although it is not shown, the energy recovery circuit may supply a voltage stored in the energy recovery circuit to the scan electrode or the sustain electrode during 1th, 2th, 3th, 4th, and 5th periods d1, d2, d3, d4, and d5 of the second type sustain signal TYPE2.

During a 13th period d13 of the first type sustain signal TYPE1 and a 6th period d6 of the second type sustain signal TYPE2, the energy recovery circuit may clamp a voltage of the scan electrode or the sustain electrode to a maximum voltage. During a 14th period d14 of the first type sustain signal TYPE1 and a 7th period d7 of the second type sustain signal TYPE2, the energy recovery circuit may recover a voltage of the scan electrode or the sustain electrode.

More specifically, the first type sustain signal TYPE1 used in the relatively small data load LOAD1 may include the 10th period d10 during which a voltage of the first type sustain signal TYPE1 rises from a ground level voltage GND to a 10th voltage V10, the 11th period d11 during which the voltage rises from the 10th voltage V10 to an 11th voltage V11, and the 12th period d12 during which the voltage rises from the 11th voltage V11 to a 12th voltage V12. In addition, the first type sustain signal TYPE1 may include the 13th period d13 during which the voltage is held at the 12th voltage V12 (i.e., a maximum voltage of the first type sustain signal TYPE1) and the 14th period d14 during which the voltage gradually falls from the 12th voltage V12 to a 13th voltage V13.

Further, the second type sustain signal TYPE2 used in the relatively large data load LOAD2 may include the 1st period d1 during which a voltage of the second type sustain signal TYPE2 rises from the ground level voltage GND to a 1st voltage V1, the 2nd period d2 during which the voltage falls from the 1st voltage V1 to a 2nd voltage V2 greater than the ground level voltage GND, the 3rd period d3 during which the voltage rises from the 2nd voltage V2 to a 3rd voltage V3 greater than the 1st voltage V1, the 4th period d4 during which the voltage falls from the 3rd voltage V3 to a 4th voltage V4 greater than the 1st voltage V1, and the 5th period d5 during which the voltage rises from the 4th voltage V4 to a 5th voltage V5 greater than the 3rd voltage V3. In addition, the second type sustain signal TYPE2 may include the 6th period d6 during which the voltage is held at the 5th voltage V5 (i.e., a maximum voltage of the second type sustain signal TYPE2) and the 7th period d7 during which the voltage gradually falls from the 5th voltage V5 to a 6th voltage V6.

In the embodiment of the invention, the maximum voltage V12 of the first type sustain signal TYPE1 may be substantially equal to the maximum voltage V5 of the second type sustain signal TYPE2.

In the second type sustain signal TYPE2, the 6th voltage V6 may be less than the 1st voltage V1. The use of the second type sustain signal TYPE2 may increase the energy recovery efficiency because of the 6th voltage V6 with a sufficiently low level. In the first type sustain signal TYPE1, the 13th voltage V13 may be less than the 10th voltage V10. The use of the first type sustain signal TYPE1 may increase the energy recovery efficiency because of the 13th voltage V13 with a sufficiently low level.

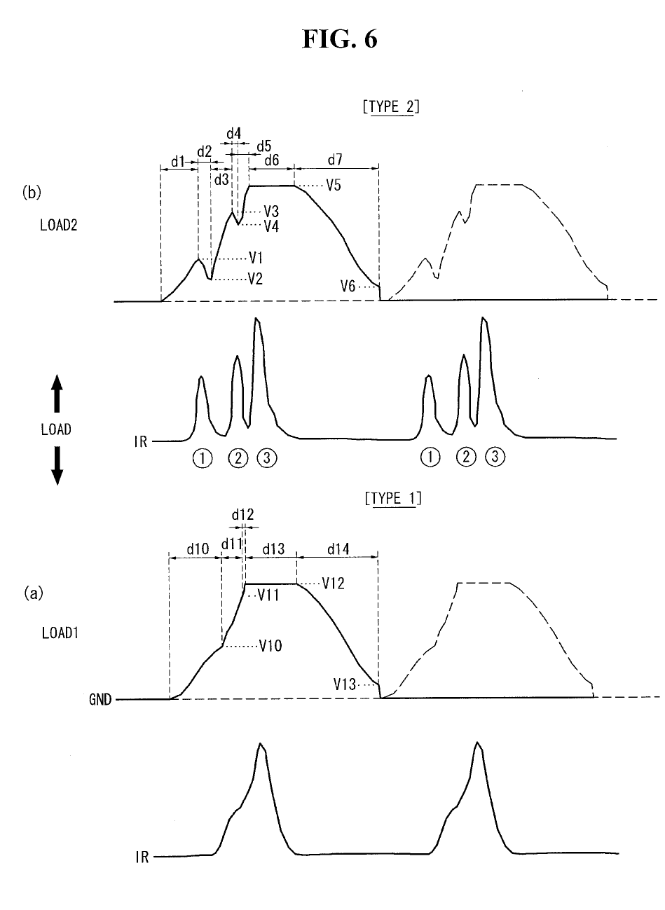

When one first type sustain signal TYPE1 is supplied to the scan electrode or the sustain electrode as shown in (a) of FIG. 6, the one first type sustain signal TYPE1 may generate one discharge. The number of discharges may be confirmed by a light waveform IR.

On the other hand, when one second type sustain signal TYPE2 is supplied to the scan electrode or the sustain electrode as shown in (b) of FIG. 6, the one second type sustain signal TYPE2 may successively generate three discharges. Intensities of the three successively generated discharges \textcircled{1}, \textcircled{2}, and \textcircled{3} may sequentially increase. Namely, the intensity of the first discharge \textcircled{1} is less than the intensity of the second discharge \textcircled{2}, and the intensity of the second discharge \textcircled{2} is less than the intensity of the third discharge \textcircled{3}.

As above, the driving efficiency can be improved by allowing the number of discharges in the sustain signals of different types used depending on the input data load to be different from each other.

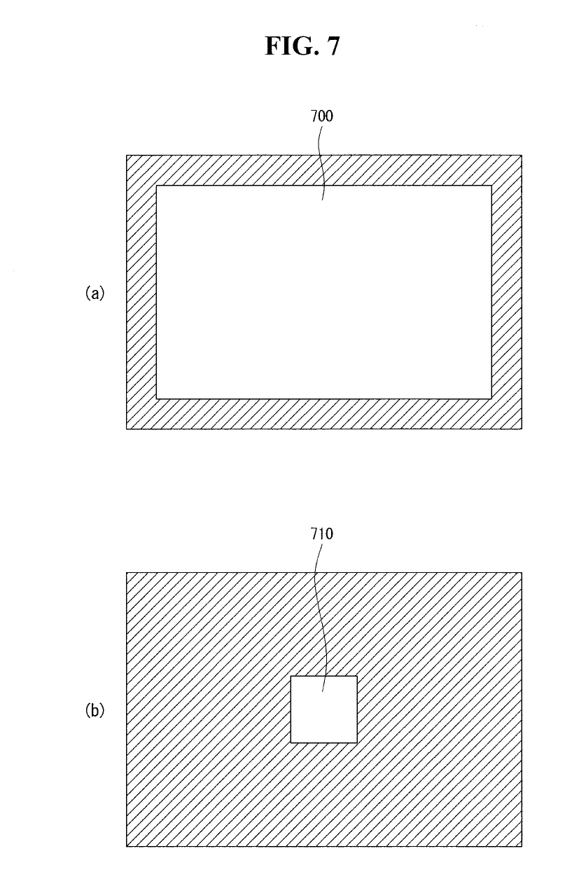

The large data load means that a large number of discharge cells are turned on. For example, when a large-sized image display area 700 is provided as shown in (a) of FIG. 7, a large number of discharge cells are turned on. Hence, it seems that the data load is relatively large.

On the other hand, when an image display area 710 whose the size is smaller than the size of the image display area 700 is provided as shown in (b) of FIG. 7, the number of turned-on discharge cells in the image display area 710 is less than the number of turned-on discharge cells in the image display area 700. Hence, the data load in the image display area 710 may be less than the data load in the image display area 700.

When the small number of discharge cells are turned on as shown in (b) of FIG. 7, a relatively small amount of discharge current is consumed. Thus, a sufficiently strong sustain discharge may occur using only the first type sustain signal TYPE1 illustrated in FIGS. 5 and 6, and a sufficiently large amount of light may be generated.

When the large number of discharge cells are turned on as shown in (a) of FIG. 7, a relatively large amount of discharge current is consumed. Thus, a sufficiently strong sustain discharge may occur using the second type sustain signal TYPE2 illustrated in FIGS. 5 and 6, and a sufficiently large amount of light may be generated. In other words, it is possible to improve the driving efficiency in the relatively large data load.

To keep the driving efficiency at a sufficiently high level in the use of the second type sustain signal TYPE2, it may be preferable that a length of the hold period d6 of the maximum voltage V5 of the second type sustain signal TYPE2 is shorter than a length of the hold period d13 of the maximum voltage V12 of the first type sustain signal TYPE1. A voltage change rate in the 7th period d7 of the second type sustain signal TYPE2 may be less than a voltage change rate in the 14th period d14 of the first type sustain signal TYPE1.

To increase an amount of light while reducing a noise, a voltage rising slope in the first and second type sustain signals TYPE1 and TYPE2 may gradually increase. For example, in the first type sustain signal TYPE1, a voltage charge rate of the 10th period d10 may be less than a voltage charge rate of the 11th period d11, and a voltage charge rate of the 11th period d11 may be less than a voltage charge rate of the 12th period d12.

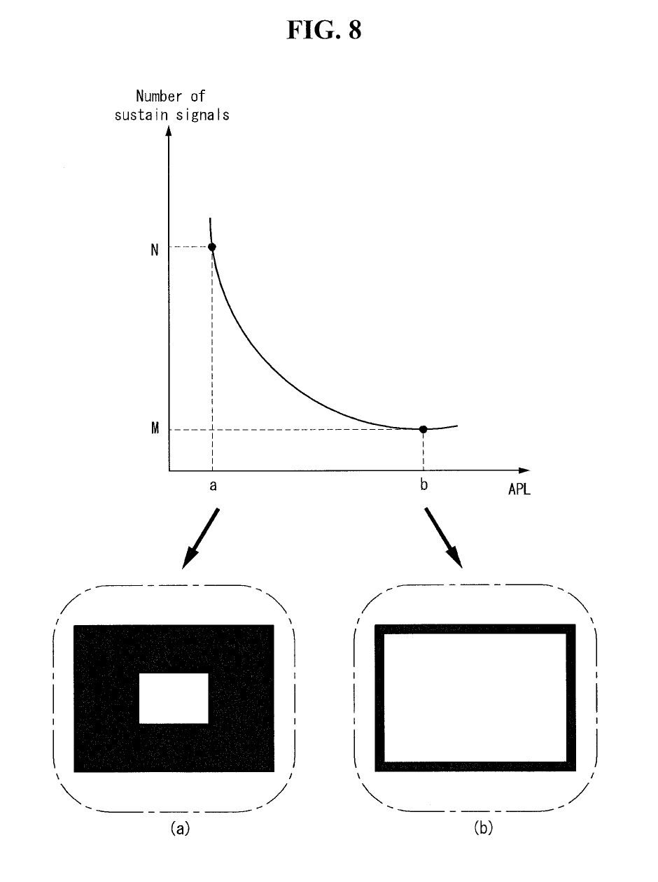

Sustain signals of different types may be used depending on an average power level (APL) of input video data. This is described in detail below with reference to FIG. 8.

The APL may be a method for adjusting the number of sustain signals in consideration of power consumption. More specifically, the APL may allow the number of sustain signals assigned to one frame to decrease in an increasing direction of power consumption and the number of sustain signals assigned to one frame to increase in a decreasing direction of power consumption.

For example, as shown in (a) of FIG. 8, when an image is displayed on a relatively small-sized portion of the screen of the plasma display panel (i.e., when the APL is relatively low), power consumption may be relatively low. Therefore, the number of sustain signals assigned to one frame may relatively increase. Hence, an entire luminance of the image may increase.

On the other hand, as shown in (b) of FIG. 8, when an image is displayed on a relatively large-sized portion of the screen of the plasma display panel (i.e., when the APL is relatively high), power consumption may be relatively high. Therefore, the number of sustain signals assigned to one frame may relatively decrease. Hence, an excessive increase in power consumption may be prevented.

For example, as shown in FIG. 8, when the APL is “a” level, the number of sustain signals assigned to one frame is N. When the APL is “b” level greater than “a” level, the number of sustain signals assigned to one frame is M less than N. In other words, the total number of sustain signals assigned to one frame in the b-level APL may be less than the total number of sustain signals assigned to one frame in the a-level APL.

The APL may increase when a large number of discharge cells are turned on, and the APL may be lowered when a small number of discharge cells are turned on. Hence, the APL may be low in a small data load, and the APL may be high in a large data load.

Accordingly, the second type sustain signal illustrated in (b) of FIG. 5 may be used in the high APL, and the first type sustain signal illustrated in (a) of FIG. 5 may be used in the low APL.

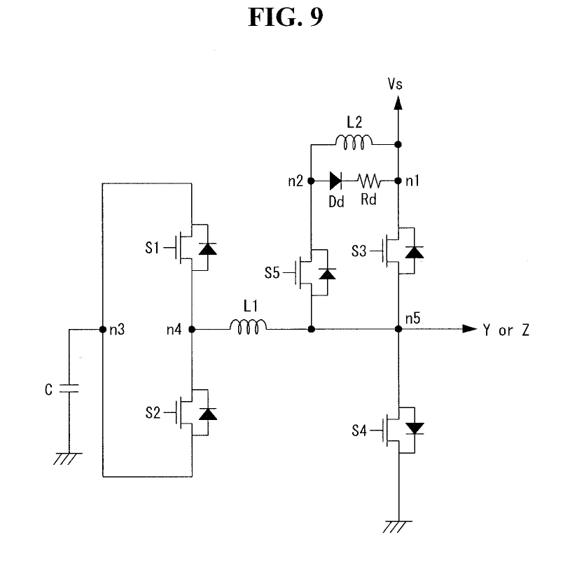

FIGS. 9 to 15 illustrate a configuration and an operation of a driver.

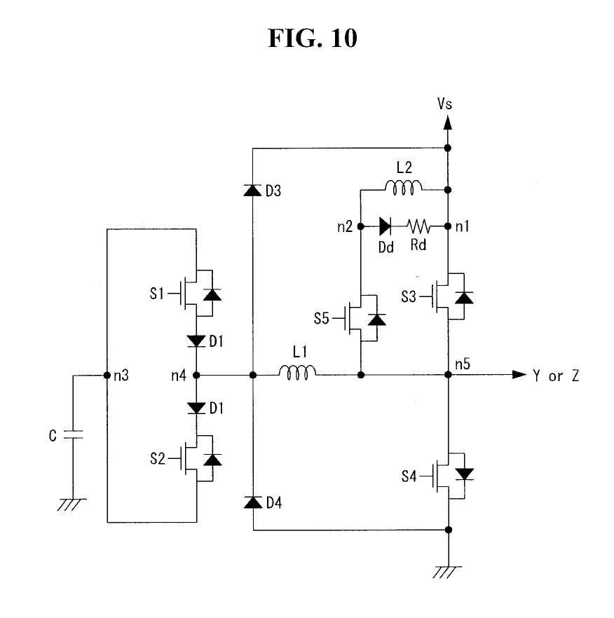

The plasma display apparatus according to the embodiment may include a driver having a configuration illustrated in FIGS. 9 and 10. More specifically, the driver may include a capacitor C, a first switch S1, a second switch S2, a first inductor L1, a second inductor L2, a third switch S3, a fourth switch S4, and a fifth switch S5.

A voltage recovered from the scan electrode or the sustain electrode may be stored in the capacitor C.

The first inductor L1 may be positioned between the capacitor C and the scan electrode or the sustain electrode. The first inductor L1 may generate resonance when the voltage stored in the capacitor C is supplied to the scan electrode or the sustain electrode and when the capacitor C recovers a voltage from the scan electrode or the sustain electrode.

The first switch S1 and the second switch S2 may be connected in parallel to each other between the first inductor L1 and the capacitor C. Namely, the first switch S1 and the second switch S2 may be connected in parallel to each other between a third node n3 and a fourth node n4. The first switch S1 may allow the voltage stored in the capacitor C to be supplied to the scan electrode or the sustain electrode through a predetermined switching operation. The second switch S2 may allow the capacitor C to recover the voltage from the scan electrode or the sustain electrode through a predetermined switching operation.

The third switch S3 may be positioned between the scan electrode or the sustain electrode and a sustain voltage source generating a sustain voltage Vs. Namely, the third switch S3 may be positioned between a fifth node n5 and the sustain voltage source. Further, the third switch S3 may allow the sustain voltage Vs to be supplied to the scan electrode or the sustain electrode through a predetermined switching operation.

The fourth switch S4 may be positioned between the scan electrode or the sustain electrode and a ground. Namely, the fourth switch S4 may be positioned between the fifth node n5 and the ground. Further, the fourth switch S4 may allow the ground level voltage GND to be supplied to the scan electrode or the sustain electrode through a predetermined switching operation.

The fifth switch S5 may be positioned between the sustain voltage source and the scan electrode or the sustain electrode to be parallel to the third switch S3. Namely, the fifth switch S5 may be positioned between a first node n1 and the fifth node n5 to be parallel to the third switch S3.

The second inductor L2 may be positioned between the first node n1 between the sustain voltage source and the third switch S3 and the fifth switch S5. Namely, the second inductor L2 may be positioned between the first node n1 and a second node n2. Further, the second inductor L2 may resonate the voltage supplied to the scan electrode or the sustain electrode through the fifth switch S5 when the fifth switch S5 is turned on.

Furthermore, a diode Dd and a resistor Rd may be positioned between the second node n2 between the fifth switch S5 and the second inductor L2 and the first node n1. The diode Dd and the resistor Rd may be connected in serial between the first node n1 and the second node n2. An anode of the diode Dd may be positioned toward the second node n2, and a cathode of the diode Dd may be positioned toward the first node n1. The diode Dd and the resistor Rd may prevent a voltage of the second node n2 from being greater than the sustain voltage Vs and may protect the fifth switch S5.

As shown in FIG. 10, the driver may include first, second, third, and fourth diodes D1, D2, D3, and D4 for operation stability. The first diode D1 may be positioned between the first switch S1 and the fourth node n4 to cut off a current flowing from the fourth node n4 to the first switch S1. The second diode D2 may be positioned between the second switch S2 and the fourth node n4 to cut off a current flowing from the second switch S2 to the fourth node n4. The third diode D3 may be positioned between the sustain voltage source and the fourth node n4 to prevent a voltage of the fourth node n4 from being greater than the sustain voltage Vs. The fourth diode D4 may be positioned between the ground GND and the fourth node n4 to prevent the voltage of the fourth node n4 from being less than the ground level voltage.

An example of an operation of the driver is described below.

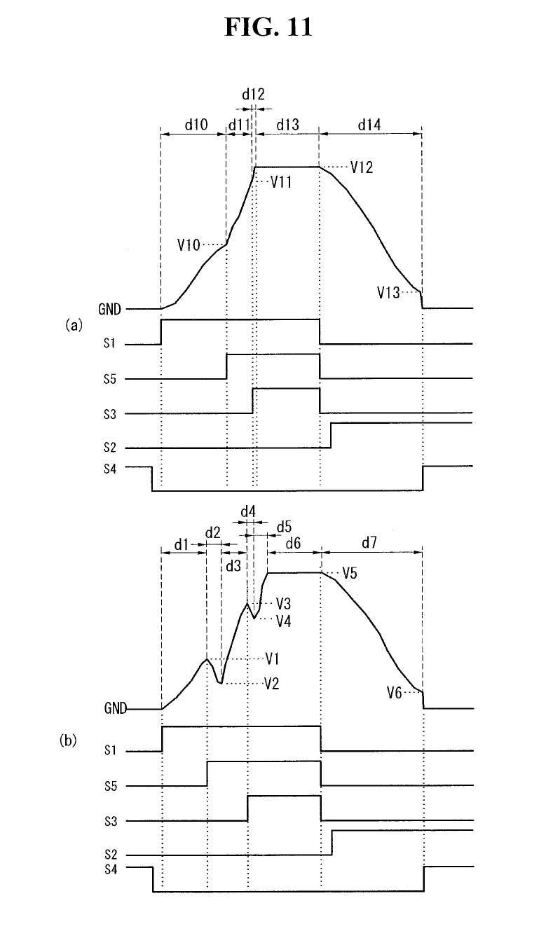

In FIG. 11, (a) illustrates an operation of the driver supplying the first type sustain signal.

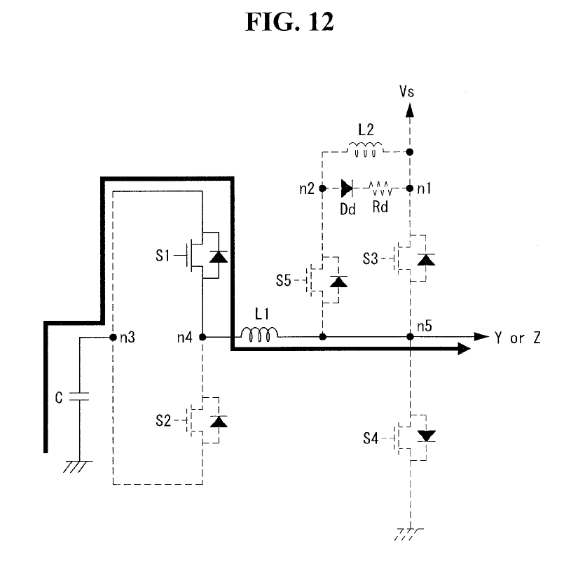

As shown in (a) of FIG. 11, during the 10th period d10, the first switch S1 may be turned on, and the second, third, fourth, and fifth switches S2, S3, S4, and S5 may be turned off. Hence, as shown in FIG. 12, the voltage stored in the capacitor C may be supplied to the scan electrode or the sustain electrode through LC resonance resulting from the first inductor L1. As a result, the voltage of the scan electrode or the sustain electrode may gradually rise from the ground level voltage to the 10th voltage V10.

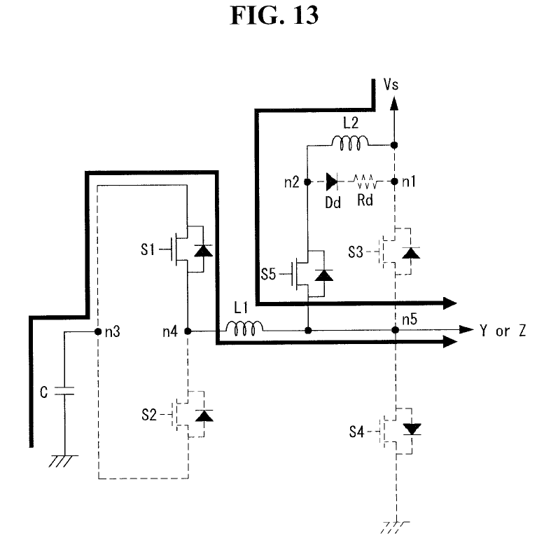

Sequentially, during the 11th period d11, the first switch S1 may remain in a turned-on state, the fifth switch S5 may be turned on, and the second, third, and fourth switches S2, S3, and S4 may remain in a turned-off state. Hence, as shown in FIG. 13, the sustain voltage Vs generated by the sustain voltage source may be supplied to the scan electrode or the sustain electrode through LC resonance resulting from the second inductor L2. As a result, the voltage of the scan electrode or the sustain electrode may gradually rise from the 10th voltage V10 to the 11th voltage V11.

An inductance of the first inductor L1 may be greater than an inductance of the second inductor L2, so that a voltage change rate in the 10th period d10 is less than a voltage change rate in the 11th period d11. In addition, the inductance of the first inductor L1 may be greater than 1 uH.

Sequentially, during the 12th period d12, the first switch S1 and the fifth switch S5 may remain in a turned-on state, the third switch S3 may be turned on, and the second and fourth switches S2 and S4 may remain in a turned-off state. Hence, the sustain voltage Vs may be supplied to the scan electrode or the sustain electrode through the third switch S3. As a result, the voltage of the scan electrode or the sustain electrode may gradually rise from the 11th voltage V11 to the 12th voltage V12.

Because the sustain voltage Vs is supplied to the scan electrode or the sustain electrode without passing through the inductor in the 12th period d12, a voltage change rate in the 12th period d12 may be greater than the voltage change rates in the 10th and 11th periods d10 and d11.

Sequentially, as the third switch S3 remains in a turned-on state during the 13th period d13, the voltage of the scan electrode or the sustain electrode may be substantially held at the maximum voltage V12.

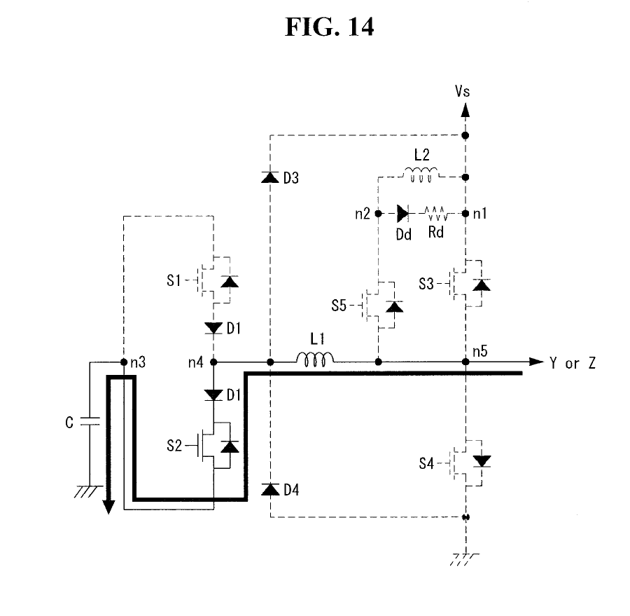

Sequentially, during the 14th period d14, the first, third, and fifth switches S1, S3, and S5 may be turned off, the second switch S2 may be turned on, and the fourth switch S4 may remain in a turned-off state. Hence, as shown in FIG. 14, the capacitor C may recover the voltage of the scan electrode or the sustain electrode through LC resonance resulting from the first inductor L1. As a result, the voltage of the scan electrode or the sustain electrode may gradually falls from the maximum voltage V12 to the 13th voltage V13. The 13th voltage V13 may be less than the 10th voltage V10. In other words, during the 14th period d14, the first type sustain signal may continuously fall from the maximum voltage V12 to the 13th voltage V13 less than the 10th voltage V10.

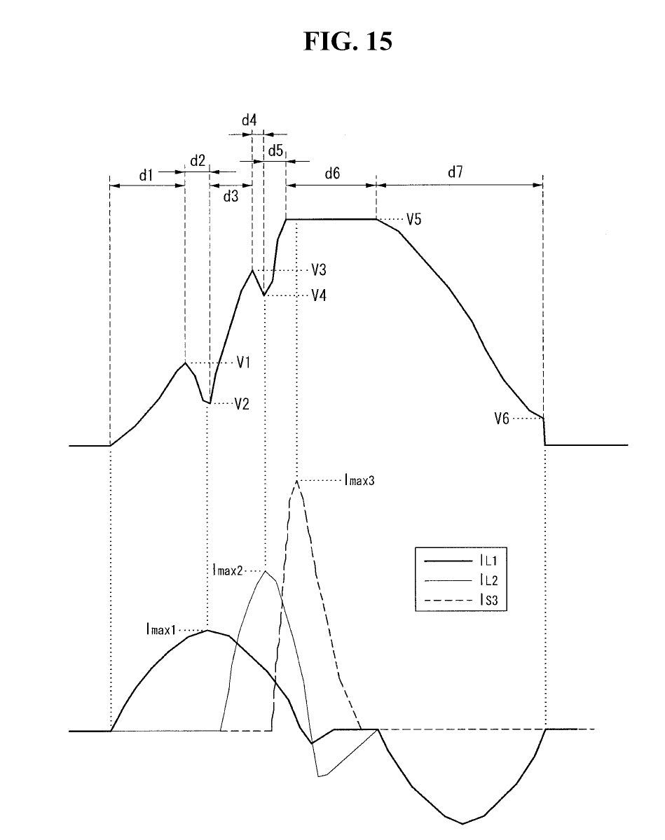

A current flowing in the first and second inductors L1 and L2 during the supply of the first type sustain signal is described below with reference to FIG. 15.

As shown in FIG. 15, a current I_{L1} flowing in the first inductor L1 may gradually increase during the first period d1 and the second period d2 and then may gradually decrease after the second period d2. A current I_{L2} flowing in the second inductor L2 may gradually increase during the third period d3 and the fourth period d4 and then may gradually decrease after the fourth period d4. Because the sustain voltage Vs is greater than the voltage stored in the capacitor C, a maximum value Imax2 of the current I_{L2} flowing in the second inductor L2 may be greater than a maximum value Imax1 of the current I_{L1} flowing in the first inductor L1.

Because the sustain voltage Vs is supplied to the scan electrode or the sustain electrode through the third switch S3 without passing through the inductor in the fifth period d5 and the sixth period d6, a maximum value Imax3 of a current I_{S3} flowing in the third switch S3 may be greater than the maximum value Imax2 of the current I_{L2} flowing in the second inductor L2 and the maximum value Imax1 of the current I_{L1} flowing in the first inductor L1.

In FIG. 11, (b) illustrates an operation of the driver supplying the second type sustain signal. A description identical or equivalent to that illustrated in (a) of FIG. 11 is briefly made or is entirely omitted.

As shown in (b) of FIG. 11, switching timing of the driver supplying the second type sustain signal is substantially the same as switching timing of the driver supplying the first type sustain signal.

More specifically, because a relatively large amount of discharge current is consumed in the relatively large data load, the voltage of the scan electrode or the sustain electrode instantaneously falls from the 1st voltage V1 to the 2nd voltage V2 at a time when the fifth switch S5 is turned on in the 2nd period d2. Hence, a discharge may first occur in the discharge cell, and the first generated discharge may gradually disappear when the voltage of the scan electrode or the sustain electrode falls from the 1st voltage V1 to the 2nd voltage V2.

Sequentially, as the fifth switch S5 remains in a turned-on state during the 3rd period d3, the sustain voltage Vs may be supplied to the scan electrode or the sustain electrode through a resonance resulting from the second inductor L2 to generate a second discharge.

Sequentially, the voltage of the scan electrode or the sustain electrode instantaneously falls from the 3rd voltage V3 to the 4th voltage V4 at a time when the 3rd switch S3 is turned on in the 4th period d4. Hence, the second discharge may gradually disappear.

Sequentially, as the 3rd switch S3 remains in a turned-on state during the 5th period d5, the sustain voltage Vs may be supplied to the scan electrode or the sustain electrode through the 3rd switch S3 to generate a third discharge.

As described above, the driver according to the embodiment of the invention may operate according to the same switching timing in the relatively large data load and in the relatively small data load.

As a consumed amount of discharge current increases in the relatively large data load, the second type sustain signal illustrated in (b) of FIG. 11 may be produced. Hence, three discharges may sequentially occur by one second type sustain signal. As a result, the driving efficiency may be improved in the relatively large data load.

Since characteristics of a current flowing in the first and second inductors L1 and L2 and the third switch S3 during the supply of the second type sustain signal are substantially the same as those illustrated in FIG. 15, a further description may be briefly made or may be entirely omitted.

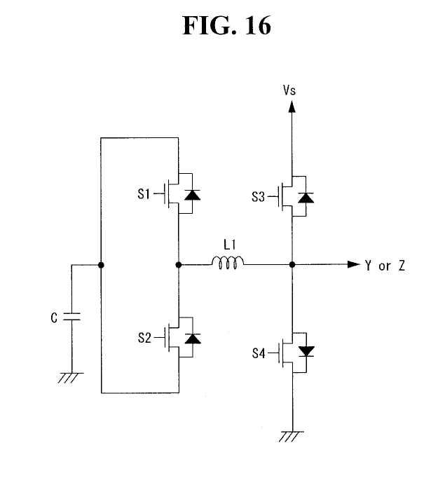

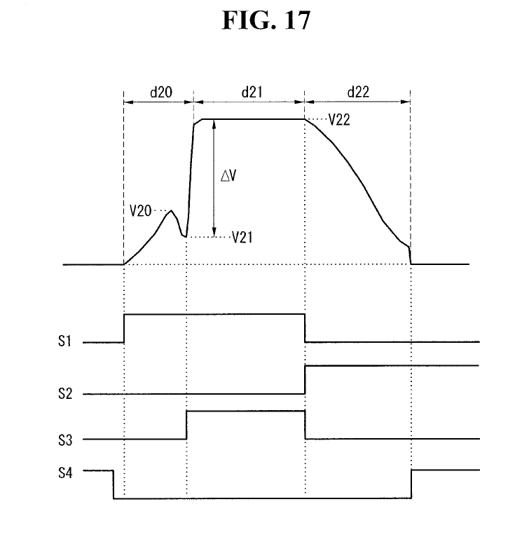

FIGS. 16 and 17 illustrate a comparative example. More specifically, FIGS. 16 and 17 illustrate the driver of FIG. 9 in which the fifth switch S5 and the second inductor L2 are omitted. Descriptions identical or equivalent to those described above are briefly made or are entirely omitted.

As shown in FIGS. 16 and 17, the first switch S1 may be turned on in a 20th period d20. Hence, a voltage of an electrode may gradually rise from a ground level voltage to a 20th voltage V20.

Because a relatively large amount of discharge current is consumed when a data load of an input image is relatively large, the voltage may fall from the 20th voltage V20 to a 21th voltage V21.

Subsequently, the third switch S3 may be turned on in the 21th period d21. Hence, the voltage may rise from the 21th voltage V21 to a 22th voltage V22 (i.e., the sustain voltage Vs). Because the voltage rises from the 21th voltage V21 to the sustain voltage Vs in the 21th period d21, a voltage having an excessively large magnitude ΔV may be instantaneously supplied to the electrode. Hence, an excessively high current instantaneously flows in the 21th period d21, and thus the driving efficiency may be reduced. If the voltage magnitude ΔV further increases, a self-erase discharge may occur. Hence, driving efficiency may be further reduced. In addition, generation of a noise and electromagnetic interference (EMI) may increase.

On the other hand, in the plasma display apparatus according to the embodiment of the invention, when the data load is relatively large, the second type sustain signal is used using the method illustrated in (b) of FIG. 11. Accordingly, the driving efficiency can be improved in the relatively large data load.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display apparatus comprising:
a plasma display panel including an electrode; and
a driver that supplies a sustain signal to the electrode in a sustain period of a subfield,
wherein the driver supplies a first type sustain signal to the electrode when a data load of an input image is a first load and supplies a second type sustain signal to the electrode when the data load of the input image is a second load greater than the first load,
wherein the second type sustain signal includes a 1st period during which a voltage of the second type sustain signal rises from a ground level voltage to a 1st voltage, a 2nd period during which the voltage falls from the 1st voltage to a 2nd voltage greater than the ground level voltage, a 3rd period during which the voltage rises from the 2nd voltage to a 3rd voltage greater than the 1st voltage, a 4th period during which the voltage falls from the 3rd voltage to a 4th voltage greater than the 1st voltage, and a 5th period during which the voltage rises from the 4th voltage to a 5th voltage greater than the 3rd voltage,
wherein the first type sustain signal includes a 10th period during which a voltage of the first type sustain signal rises from the ground level voltage to a 10th voltage, a 11th period during which the voltage rises from the 10th voltage to an 11th voltage, and a 12th period during which the voltage rises from the 11th voltage to a 12th voltage.

2. The plasma display apparatus of claim 1, wherein the 12th voltage is substantially equal to the 5th voltage.

3. The plasma display apparatus of claim 1, wherein a length of a hold period of a maximum voltage of the second type sustain signal is shorter than a length of a hold period of a maximum voltage of the first type sustain signal.

4. The plasma display apparatus of claim 1, wherein a voltage change rate in the 10th period of the first type sustain signal is less than a voltage change rate in the 11th period of the first type sustain signal, and a voltage change rate in the 11th period is less than a voltage change rate in the 12th period of the first type sustain signal.

5. The plasma display apparatus of claim 1, wherein a voltage change rate in the 1st period of the second type sustain signal is less than a voltage change rate in the 3rd period of the second type sustain signal, and a voltage change rate in the 3rd period is less than a voltage change rate in the 5th period of the second type sustain signal.

6. The plasma display apparatus of claim 1, wherein the first type sustain signal includes a falling period during which the voltage of the first type sustain signal gradually falls from a maximum voltage of the first type sustain signal, and the second type sustain signal includes a falling period during which the voltage of the second type sustain signal gradually falls from a maximum voltage of the second type sustain signal,
wherein a voltage change rate in the falling period of the second type sustain signal is less than a voltage change rate in the falling period of the first type sustain signal.

7. The plasma display apparatus of claim 6, wherein the voltage of the second type sustain signal gradually falls from the maximum voltage of the second type sustain signal to a 6th voltage less than the 1st voltage in the falling period of the second type sustain signal,
wherein the voltage of the first type sustain signal gradually falls from the maximum voltage of the first type sustain signal to a 13th voltage less than the 10th voltage in the falling period of the first type sustain signal.

8. The plasma display apparatus of claim 1, wherein as a number of turned-on discharge cells increases, the data load increases.

9. A plasma display apparatus comprising:
a plasma display panel including an electrode; and
a driver that supplies a sustain signal to the electrode in a sustain period of a subfield,
wherein the driver supplies a first type sustain signal to the electrode when a data load of an input image is a first load and supplies a second type sustain signal to the electrode when the data load of the input image is a second load greater than the first load,
wherein one first type sustain signal generates one discharge, and one second type sustain signal generates three discharges.

10. The plasma display apparatus of claim 9, wherein intensities of the three discharges generated by the one second type sustain signal sequentially increase.

11. The plasma display apparatus of claim 9, wherein as a number of turned-on discharge cells increases, the data load increases.

12. A plasma display apparatus comprising:
a plasma display panel including an electrode; and
a driver that supplies a sustain signal to the electrode in a sustain period of a subfield, the driver including:
a capacitor;
a first inductor positioned between the capacitor and the electrode;
first and second switches that are positioned between the first inductor and the capacitor to be parallel to each other;
a third switch positioned between the electrode and a sustain voltage source generating a sustain voltage;
a fourth switch positioned between the electrode and a ground; and
a fifth switch and a second inductor that are positioned between a node between the electrode and the first inductor and the sustain voltage source.

13. The plasma display apparatus of claim 12, wherein the fifth switch is positioned between the sustain voltage source and the electrode to be parallel to the third switch,
wherein the second inductor is positioned between a first node between the sustain voltage source and the third switch and the fifth switch.

14. The plasma display apparatus of claim 13, wherein a diode and a resistor are positioned between a second node between the fifth switch and the second inductor and the first node to be parallel to each other.

15. The plasma display apparatus of claim 14, wherein an anode of the diode is positioned toward the second node, and a cathode of the diode is positioned toward the first node.

16. The plasma display apparatus of claim 12, wherein an inductance of the first inductor is greater than an inductance of the second inductor.

17. The plasma display apparatus of claim 16, wherein the inductance of the first inductor is greater than 1 uH.

18. The plasma display apparatus of claim 12, wherein a maximum current flowing in the second inductor is greater than a maximum current flowing in the first inductor during a supply of a sustain signal to the electrode.

19. The plasma display apparatus of claim 12, wherein the driver further includes a diode between a node between the first and second switches and the first inductor and the sustain voltage source, and a cathode of the diode is positioned toward the sustain voltage source.

20. The plasma display apparatus of claim 12, wherein the driver further includes a diode between a node between the first and second switches and the first inductor and the ground, and an anode of the diode is positioned toward the ground.
